(19) United States
(12) Patent Application Publication
(10) Pub. No.: US 2005/0244745 A1
(43) Pub. Date: Nov. 3, 2005

(54) Photoresist compositions with si-component

(75) Inventors: James F. Cameron, Cambridge, MA (US); Sheri L. Ablaza, Stow, MA (US); Yusuhiro Suzuki, Cambridge, MA (US)

Correspondence Address: Peter F. Corless;Edwards & Angell, LLP, P.O. Box 55874, Boston, MA, 02205, US

(73) Assignee: Rohm and Haas Electronic Materials LLC, Marlborough, MA (US)

(21) Appl. No.: 11/026,181

(22) Filed: Dec. 30, 2004

Related U.S. Application Data
(60) Provisional application No. 60/533,488, filed on Dec. 30, 2003.

(51) Int. Cl. G03C 1/492

(52) U.S. Cl. 430/270.1

(57) ABSTRACT

Photoresist compositions are provided with a silicon-containing component and an added sulfonic acid component. Preferred resists of the invention also contain a non-hydroxylic solvent such as propylene glycol methyl ether acetate as the primary or sole solvent. Preferred resist compositions of the invention can exhibit enhanced stability during storage between manufacture and use.

### BACKGROUND OF THE INVENTION

1. Field of the Invention

This invention relates to photoresist compositions with a silicon-containing component and an added sulfonic acid component. Preferred resists of the invention also contain a non-hydroxylic solvent such as propylene glycol methyl ether acetate as the primary or sole solvent. Preferred resist compositions of the invention can exhibit enhanced stability during storage between manufacture and use.

2. Background

Photoresists are photosensitive films used for transfer of images to a substrate. A coating layer of a photoresist is formed on a substrate and the photoresist layer is then exposed through a photomask to a source of activating radiation. The photomask has areas that are opaque to activating radiation and other areas that are transparent to activating radiation. Exposure to activating radiation provides a photoinduced chemical transformation of the photoresist coating to thereby transfer the pattern of the photomask to the photoresist-coated substrate. Following exposure, the photoresist is developed to provide a relief image that permits selective processing of a substrate.

A photoresist can be either positive-acting or negative-acting. For most negative-acting photoresists, those coating layer portions that are exposed to activating radiation polymerize or crosslink in a reaction between a photoactive compound and polymerizable agents of the photoresist composition. Consequently, the exposed coating portions are rendered less soluble in a developer solution than unexposed portions. For positive-acting photoresists, exposed portions are rendered more soluble in a developer solution while areas not exposed remain comparatively less developer soluble. In general, photoresist compositions include at least a resin binder component and a photoactive agent.

The increasing density of integrated circuits has created a need for higher resolution patterning capabilities. One method of improving resolution involves using a shorter wavelength light during pattern formation. Shorter wavelengths of approximately 200 to 280 nm may be obtained by using a deep UV (“DUV”) source such as a mercury/xenon (“Hg/Xe”) lamp with appropriate filters. Additionally, KrF (248 nm) or ArF (193 nm) excimer lasers may be used as exposure sources.

In addition to using shorter wavelengths during exposure, it is also desirable to use a thinner layer of resist. However, the major drawback of using a thin layer of resist is that the variation of resist thickness over a diffusion step on a substrate and into an etched pattern increases as the pattern size becomes smaller. This variation means that the dimensions of any pattern being imaged in the resist will vary as the step geometry is traversed. Therefore, in a single layer resist system, the lack of dimensional control on the wafer can create different line widths throughout the resist which reduces the quality of the electronic package.

To attempt to improve dimensional control, bilayer (or bilevel or multilevel) resist systems have been utilized. In a typical bilevel system, a bottom resist is first applied to a substrate to planarize wafer topography. The bottom resist is cured and a second thinner imaging top resist is then applied over the bottom resist. The top resist is then soft baked, and patterned (or imaged) using conventional resist exposure and development, followed by etch transfer of the top pattern through the bottom resist using the top resist pattern as an etch mask. Positive resists are commonly used in bilayer applications and are typically based on novolac resins, which are condensation polymers of phenols or substituted phenols and formaldehyde. See, generally, Sugiyama et al., Positive Excimer Laser Resists Prepared with Aliphatic Diazoketones, Soc. Plastics Eng., Conference Proceeding, pages 51-60 (November 1988); and U.S. Pat. Nos. 4,745,169; 5,338,818; 5,619,396; 5,731,126; 6,296,985; and 6,340,734. Additional silicon photoresists are disclosed in WO 02/091083; U.S. Patent Publication 2002/0090572; and U.S. Pat. No. 5,378,585.

Storage stability is typically of high importance for a photoresist. Generally, after photoresist manufacture, a resist is stored for several months or more prior to use by a device manufacturer. Any resist degradation during storage typically will only compromise lithographic properties. See EP12844434 of the Shipley Company.

It thus would be desirable to have new photoresist compositions. It would be particularly desirable to have new photoresist compositions that can exhibit enhanced storage stability.

### SUMMARY OF THE INVENTION

We have now provide new photoresist compositions that in general comprise an silicon-containing component (Si-component) such as a silicon resin and a sulfonic acid. More particularly photoresists of the invention preferably comprise:
1) an Si-component, particularly a resin that comprises Si atoms as pendant or backbone units, e.g. a poly(siloxane) or poly(silsesquioxane);
2) a photoactive component, such as one or more photoacid generator compounds; and
3) a sulfonic acid compound, i.e. a compound that comprises a moiety —S(O)₂O, which is typically an organosulfonic compound such RS(O)₂O where R is an organic group such as optionally substituted alkyl including halo(C₁₋₂₀)alkyl particularly fluoro(C₁₋₂₀)alkyl such as triflate (CF₃S(O), optionally substituted aryl such as optionally substituted carbocyclic aryl particularly optionally substituted phenyl, and the like.

We have surprisingly found that addition of a sulfonic acid to a Si-resist formulation can provide significantly enhanced stability (e.g. enhanced resolution including smoother profile of relief image) over prolonged periods relative to comparable resists that do not contain the added acid. See, for instance, the results set forth in the examples which follow.

Preferably, the sulfonic acid compound is formulated in a photoresist composition in salt form, i.e. as an acid addition salt. The cation component of the salt preferably is organic such as an organic amine. Even more preferred is where the cation component has a molecular weight sufficient to inhibit volatilization of the sulfonic acid salt during lithographic processing (particularly pre-exposure and post-exposure bakes). For example, preferably the cation component has a molecular weight of at least about 50, 60, 70, 80, 90, or 100 daltons and/or comprises one or two or more aromatic or alicyclic groups such as phenyl, naphthyl, anthracenyl, adamantly, isobornyl and the like.

In a preferred aspect of the invention, a photoresist composition is formulated with one or more solvents that do not contain a hydroxy or carboxy moiety (i.e. one or more non-hydroxylic solvents) such as propylene glycol monomethyl ether acetate or other glyocol alkyl ether acetates, and the like. Preferably, the major portion of the solvent component of a photoresist will be comprised of one ore more non-hydroxylic solvents, e.g. of all solvent present in a photoresist composition (i.e. total solvent), preferably at least about 60 weight percent of that total solvent will be one or more non-hydroxylic solvents such as propylene glycol monomethyl ether acetate, more preferably at least about 70, 80, 90, 95, 98 or 99 weight percent of the total solvent of a photoresist composition will be one or more non-hydroxylic solvents such as propylene glycol monomethyl ether acetate. In a preferred aspect, a photoresist composition of the invention will only contain one or more solvents that are non-hydroxylic solvents, e.g. the resist may have a sole solvent or 100 weight percent of that total solvent will be one or more non-hydroxylic solvents such as propylene glycol monomethyl ether acetate.

We have further found that formulation of an Si-containing photoresist composition with such non-hydroxylic solvent(s) together with a sulfonic acid compound can provide particularly enhanced storage stability.

Preferred photoresists of the invention are positive chemically-amplified resists that contain a resin and a photoactive component. Particularly preferred resists also contain an added base such as an amine, particularly amine salts such as a salt of a tetraalkyl ammonium compound.

Resists of the invention can be prepared by a variety of methods. In one preferred method, the resist formulation is preferred and the acid is added to the formed resist. Alternatively, the acid also may be formulated together with all other resist components, i.e. the resin, photoacid generator, basic component and acid may be added together to solvent carrier.

For short-wavelength imaging, particularly sub-nm 200 imaging, preferably a photoresist polymer component has low aromatic content to provide enhanced transparency to the exposure radiation. For instance, preferred polymers for such short wavelength imaging will be substantially free of aromatic groups, e.g. less than about 5, 4, 3, 2, 1 or 0.5 mole percent aromatic groups based on total polymer units. Even more preferred will be polymers that are completely free of aromatic groups.

Polymers of the invention also suitably may contain phenolic or other aromatic groups, particularly where the polymer is used in a resist imaged at higher wavelengths such as 248 nm. Such polymers that contain aromatic groups may be provided e.g. by polymerization of a phenyl group substituted with a trichlorosilyl group, trialkoxysilyl, and the like.

Preferred polymers of the invention may contain two, three, four or more distinct repeat units. In such higher order polymers, a variety of other repeat units may be utilized. For instance, repeat units that contain aromatic or alicyclic groups may be utilized to provide etch resistance. Repeat units that contain a photoacid-labile or fluorinated alcohol may be utilized to provide desired contrast.

Preferred types of distinct repeat units of a resist resin can be categorized among the following: 1) aqueous-base solublizing groups; 2) groups with photoacid-labile groups; and 3) so-called “inert” groups, i.e. groups that are free of any hydroxy, carboxy or other aqueous base-solublizing groups or any photoacid-labile groups. A single repeat unit also may provide more than one of the above function, e.g. a single repeat unit have both a base-solubilizing moiety and a photoacid-labile group.

As referred to herein, aqueous-base solubilizing groups are polymer units that can facilitate dissolution of the polymer in aqueous alkaline solutions (photoresist developers). Exemplary preferred aqueous-base solubilizing groups include halogenated alcohols particularly fluorinated alcohols such as hexafluoropropyl alcohol; sulfonamides including substituted sulfonamides such as halide-substituted sulfonamides particularly fluorinated sulfonamides (e.g. —NHSO₂CF₃; carboxylic acids including substituted carboxylic acids such as halogenated carboxylic acids particularly a fluorinated carboxylic acid e.g. a moiety of the formula —CF₂COOH; phenolic groups including ring-substituted phenolic groups; thiol groups; and the like. Preferred polymers of the invention may contain aqueous-base solubilizing groups in an amount of at least about 20 mole percent based on total units of the Si-polymer, more preferably at least about 30, 35, 40, 45 or 50 mole percent of aqueous-base solubilizing groups such as a fluorinated alcohol based on total units of a Si-polymer.

So-called “inert” polymer units are free of photoacid-labile groups and aqueous-solubilizing groups, e.g. groups that are free of photoacid-labile ester or acetal moieties, or hydroxy, carboxy or sulfonic acid moieties. Preferred repeat units of this type include carbocyclic aryl (e.g. phenyl or naphthyl) or alkyl (inclusive of alkylidene and other branched groups and non-aromatic alicyclic groups such as adamantyl, norbornyl, cyclohexyl, isobornyl, etc.) groups that are not substituted with such photoacid-labile or aqueous, alkaline solubilizing moieties, e.g. alkyl, phenyl or naphthyl groups that are either unsubstituted or substituted by one or more halo, unsubstituted alkyl, non-photoacid labile alkoxy, mesyl or other sulfonic esters such as those of the formula C₁₋₈alkylSO₃— and the like.

Negative-acting resists of the invention typically will contain an agent for crosslinking of one or more of the components of the resist, typically a separate crosslinker component such as an amine-based reagent, e.g. a melamine or benzoguanamine resin. Resins used in negative-acting photoresists preferably contain primary or secondary alcohol moieties.

Preferred silicon polymers use in photoresists of invention imaged at sub-300 nm wavelengths such as 248 nm are disclosed in U.S. Published Application 2003-099899 to Gronbeck et al. and assigned to the Shipley Company, incorporated herein by reference. As disclosed in that published application, silicon polymers are described useful in both chemically-amplified positive-acting photoresists and negative-acting photoresists.

Preferred silicon polymers for use in photoresists imaged at sub-200 nm wavelengths such as 193 nm or 157 nm are disclosed in U.S. Provisional Application No. 60/420,056, filed Oct. 21, 2002; U.S. Provisional Application 60/451,580 filed Mar. 3, 2003; and International Application WO 03077025, all of which are incorporated herein by reference. International Application WO 03077025 discloses in particular polymer systems useful for negative-acting photoresists.

Preferred silicon polymers for imaging at sub-300 nm and sub-200 nm also are disclosed in the examples which follow.

Photoresists of the invention are preferably employed in multilayer lithography systems. More particularly, preferred uses of resists of the invention include application of a first organic polymer coating on a substrate, e.g. a semiconductor microelectronic wafer, and applying thereover a photoresist of the invention. The organic bottom layer suitably may be non-photoimageable (e.g. not contain a photoacid generator compound) but is thermally crosslinked prior to application of the resist layer. The bottom layer may comprise a phenolic polymer such as a novolac admixed with a thermal acid generator compound and a crosslinker. Use of such a bottom layer can enable application of a very thin top resist layer.

The invention also provides methods for forming relief images, including methods for forming a highly resolved relief image such as a pattern of lines where each line has essentially vertical sidewalls and a line width of about 0.40 microns or less, and even a width of about 0.2, or 0.10 microns or less, such as lines having widths of 80 nm or less. The invention further provides articles of manufacture comprising substrates such as a microelectronic wafer substrate (e.g. a wafer having a diameter of less than 20 or 10 inches), optoelectronic device substrate, waveguide or liquid crystal display substrate or other flat panel display substrate having coated thereon a polymer, photoresist or resist relief image of the invention. The invention also includes methods to produce such articles of manufacture, which comprise use of a photoresist of the invention.

Other aspects of the invention are disclosed infra.

### DETAILED DESCRIPTION OF THE INVENTION

As discussed above, we now provide new photoresist compositions that contain a sulfonic acid compound. Preferred sulfonic acids are organic compounds and formulated in a resist as a salt.

An organic sulfonic acid component of a resist suitably has a pKa (as measured in water at 25° C.) of 0 or higher, particularly a pKa of from about 0.5 to 5.5, more preferably a pKa of from about 0.5 or 1 to about 3.5 or 4 or 4.5.

Preferred acids used in a photoresist of the invention have a molecular weight of at least about 40 or 50, more preferably at least about 55, 6, 70, 80, 90 or 100. Polymeric acids may be used, but are less for preferred for at least some applications. Suitable oligomeric or polymeric added sulfonic acid components may have molecular weights of at least 500 or greater, such as 1000, 1500, 2000, 2500, 3000, 3500, 4000, 4500, 5000 or greater.

The added sulfonic acid component may be suitably employed within a wide concentration range in a photoresist composition. Greater storage stability may be possible with use of greater amounts of acid. Exemplary preferred amounts of the added sulfonic acid component are set forth in the examples which follow.

Suitable amounts of the added sulfonic acid component include at least 0.25 weight percent of the sulfonic acid component based on total solids (all components except solvent carrier) of a resist, more preferably at least about 0.5, 0.75, 0.8, 0.9, 1, 1.25, 1.5, 1.75, 2, 3, 4, or 5 weight percent of the sulfonic acid component based on total solids (all components except solvent carrier) of a resist. Generally preferred is use of the sulfonic acid component in an amount of 0.5 to about 1.5 or 2 weight percent more preferably from about 0.75 to about 1.5 or 2 weight percent based on total solids of the resist.

Also preferred is use of the sulfonic acid component in a weight excess relative to a basic additive (e.g. amine additive such as a tetraalkyl ammonium salt) of a resist, e.g. where the added acid component is present in about a 2, 3, 4, 5, 6, 7, 8, 9, 10, 15, 20 or 30-fold weight excess relative to a basic additive component.

Further preferred is where the sulfonic acid component is used in a weight amount that is less than the weight of the photoacid generator(s) used in the resist, e.g. the weight amount of the sulfonic acid component in no more than about 10, 20, 30, 40, 50, 60, 70, or 80 weight percent of the total weight of the photoacid generator(s) present in the resist.

As discussed above, especially preferred resist systems of the invention comprises a sulfonic acid in a salt form, particularly where the sulfonic acid is complexed with an organic cation such as an organic amine, although the sulfonic acid component also may be complexed with an inorganic cation.

It also will be understood that the added sulfonic acid component is a resist material that is distinct from a photoactive component (e.g. one or more photoacid generators) of the resist composition. Thus, for instance, the added sulfonic acid component will be distinct from the photoacid generator compounds described herein and may not undergo any reaction upon treatment with patterned activating radiation used to image a coating layer of the resist, i.e. the added sulfonic acid component need not be photoactive in the manner as a photoacid generator compound and can be suitably effectively inert to exposure radiation.

As discussed above, photoresists of the invention typically contain a resin component and a photoactive component. Positive photoresists of the invention preferably contain a resin that comprises one or more photoacid-acid labile moieties (e.g. ester or acetal groups) and one or more photoacid generator compounds (PAGs). The photoacid-labile moiety can undergo a deblocking reaction to provide a polar functional group such as hydroxyl or carboxylate. Preferably the resin component is used in a resist composition in an amount sufficient to render the resist developable with an aqueous alkaline solution.

Preferred PAGS can be photoactivated by exposure radiation having a wavelength of 248 nm, 193 nm or 157 nm.

Generally preferred polymers of the invention include those that contain Si atoms as a component of the polymer backbone, e.g. Si—O linkages, rather than a polymer that does not contain Si atoms as part of the backbone or substantial part thereof, but rather as pendant groups. More particularly, preferred polymers include those where at least 5 percent of the total number of atoms in the polymer backbone are Si atoms, or where at least about 10, 15, 20, 25, 30, 35, 40, 45, or 50 percent of the total number of atoms in the polymer backbone are Si atoms.

Preferred polymers of the invention include those that are formed from polymerization of a silyl halide or silyl alkoxide, particularly a silyl trihalide or trialkoxy silane such as reagent of the formula R—Si(halide)₃ e.g. R—Si(Cl)₃. The R moiety suitably may be aromatic (e.g. phenyl or naphthyl) or non-aromatic such as an optionally substituted alkyl or alicyclic groups such as norbornyl, adamantyl or the like. Such R groups may be substituted by a photoacid-labile group e.g. acid-labile ester such as t-butyl ester or acetal group, or an acetal group, or by aqueous base-solubilizing groups such as a fluorinated alcohol, sulfonamide, thiol, or the like.

As mentioned above, preferred photoacid-labile groups of polymers of the invention include photoacid-labile ester or acetal groups, such as may be grafted onto —OH groups.

For instance, a haloacetate reagent such as tert-butyl chloroacetate (ClCH₂CO₂C(CH₃)₃) may be reacted with a hydroxy moiety such as a phenolic hydroxy. A carbonate reagent also may be reacted with a hydroxy moiety to provide pendant photoacid-labile esters, e.g. di-tert-butyl dicarbonate (O[CO₂C(CH₃)₂]₂) may be reacted with polymer hydroxy groups to provide pendent acid-labile ester groups. Reactions of such haloacetate or dicarbonate reagents may be suitably conducted under either acidic or basic conditions such as in the presence of potassium t-butoxide or N,N-dimethylaminopyridine. Basic reaction conditions are generally preferred.

A vinyl ether compound also suitably may be grafted onto a polymer hydroxy moiety to provide a photoacid-labile acetal group, e.g. a compound having at least one —(CH═CH)—O— groups such as ethylvinyl ether, t-amylvinyl ether, t-butylvinyl ether, vinylisobutyl vinyl ether, vinylpropyl ether, vinyl-2-ethylhexyl ether, vinyloctadecyl ether, and the like, as well as compounds that have two vinyl groups such as hydroxybutylvinyl ether, butanediol-1,4-divinyl ether, cyclohexylvinyl ether, hexanedioldivinyl ether, and the like, as well as compounds having three vinyl groups such triethyleneglycol divinyl ether, diethyleneglycol monovinyl ether, and the like, as well as compounds having 4 or more vinyl groups such as 1,4-cyclohexanoldimethanoldivinyl ether, propenyl ether of propylene carbonate, 1,1,1-tris(vinyloxymethyl)ethane, cyclohexanedimethanolmonovinyl ether, and the like.

Suitably, to provide acetal photoacid-labile groups, such vinyl ether compounds may be grafted onto a hydroxy group (e.g. a phenolic group or alcohol group such as C₁₋₁₂hydroxyalkyl) under acidic conditions preferably after dissolving the hydroxy-containing compound and the vinyl ether reagent in a suitable solvent such as one or more of acetone, tetrahydrofuran, diglyme and dioxane. Suitable acid catalysts to use to provide acidic conditions include hydrochloric acid, sulfric acid, malonic acid and/or a sulfonic acid. Preferably, the molar ratio of free hydroxyl groups to the vinyl ether compound does not exceed 1 to 1, and more preferably the hydroxyl groups are present in a molar excess (e.g. 2:1) relative to the vinyl ether compound. In particular, a preferred synthesis includes grafting vinyl ether onto a preformed Si polymer having hydroxy groups, where only a portion of the polymer hydroxy groups are blocked with photoacid-labile groups and a portion of the polymer hydroxy groups remain unblocked as aqueous, alkaline developable groups.

Preferred repeat units that can contribute to aqueous developability of a photoresist containing the polymer include hydroxy, carboxy and other polar preferably acidic groups such as sulfonic acid and the like. For instance, a preferred repeat unit of this type is a hydroxy-containing unit, such as a phenolic unit, or an alcohol unit. However, for at least many preferred aspects of the invention, references herein to aqueous base-solubilizing groups or other similar term does not include a group containing a silanol moiety.

In such copolymers, units that are free of photoacid-labile and aqueous, alkaline developing groups will be free of moieties as discussed above, i.e. photoacid-labile ester or acetal moieties, or hydroxy, carboxy or sulfonic acid moieties. Preferred repeat units of this type include phenyl or alkyl groups that are not substituted with such photoacid-labile or aqueous, alkaline developing moieties; e.g. preferred repeat units of this type are alkyl (including cycloalkyl such as norbornyl) or phenyl groups that are either unsubstituted or substituted by one or more halo, unsubstituted alkyl, non-photoacid labile alkoxy, sulfonyl acid esters, and the like. Such substituents should be substantially stable (i.e. not undergoing a deblocking reaction) under typical lithographic conditions (e.g. pre-exposure thermal treatment of up to 140° C. for 1-2 minutes; exposure; post-exposure thermal treatment of up to about 160° C. for 1-2 minutes; and/or development with an aqueous, alkaline developer solution). Preferred substituents that are non-photoacid-labile and do not substantially promote aqueous developability useful for this type of repeat unit are disclosed as inert blocking groups in U.S. Pat. Nos. 5,736,536 and 5,541,263 both to Thackeray et al. of the Shipley Company. As disclosed in those patents, suitable substituents that are substantially inert to lithographic processing and do not substantially increase aqueous, alkaline developability of a resist containing the polymer include alkoxy groups such as methoxy, ethoxy, propoxy, n-butoxy, sec-butoxy, etc.; alkyl esters represented by RCOO— where R is preferably an alkyl group having 1 to 6 carbon atoms such as methyl, ethyl, propyl, isopropyl, butyl, etc.; sulfonyl acid esters include both alkyl (e.g. C₁₋₆alkyl) are carbocyclic aryl esters such as methane sulfonyl, ethane sulfonyl, propane sulfonyl, benzene sulfonyl, and toluene sulfonyl esters, etc. All those groups can be grafted onto hydroxy groups as discussed above to form sulfonyl esters, e.g. by reaction of an alkylhalide such alkylchloride to form an alkoxy group, or an acid halide such as acid chloride to form an alkylester.

Such Si polymers containing two or three distinct repeat can be readily prepared. For instance, a hydroxy-Si reagent can be polymerized such as a hydroxylalkyl silyl reagent. A formed hydroxy-Si polymer can be functionalized to provide multiple distinct repeat units, e.g. pendant hydroxy groups can be reacted to have both photoacid-labile groups (such as by reaction of a dicarbonate or a halocetate ester as discussed above) and non-photoacid-labile groups such as provided by reaction of a sulfonyl acid or acid chloride or the like. Preferably, those distinct groups are reacted sequentially with the pre-formed hydroxy Si polymer, although it is possible to make both additions to the pre-formed polymer in a single reaction sequence. Preferably, a portion of the hydroxy moieties are left unreacted (i.e. unsubstituted) to provide aqueous, alkaline developing enhancing OH groups.

As mentioned above, preferred Si-polymers for use in a negative-acting resist composition will contain primary and secondary hydroxy moieties, suitably primary or second alcohol groups that may be present as hydroxyC₁₋₂₀alkyl groups. Such primary and secondary hydroxy can be effective sites or moieties for crosslinking.

Preferred polymers of the invention may be prepared as generally exemplified in Examples 1 through 7 which follow and include both syntheses of monomers and polymers.

Thus, for instance, Example 5 below exemplifies preparation of a substituted sulfonamide silyl reagent (trihalide silyl reagent) through reaction of an unsaturated alkyl amine with a substituted sulfonyl chloride to form an unsaturated substituted sulfonamide. HSiCl₃ is then reacted across the carbon-carbon double bond of the formed unsaturated sulfonamide preferably in the presence of a metal catalyst such as a Pt catalyst and at elevated temperature, e.g. at reflux temperature of an aromatic solvent such as toluene or xylene. The formed trihalide silyl reagent then can be reacted with other silyl reagents to form Si-polymer with substituted sulfonamide groups, as exemplified in Example 5 below.

A thiol silyl reagent (e.g. trihalide silyl reagent) can be formed by similar procedures. For instance, an unsaturated alkyl sulfide e.g. allyl mercaptancan be reacted with HSiCl₃ preferably in the presence of a metal catalyst such as a Pt catalyst and at elevated temperature, e.g. at reflux temperature of an aromatic solvent such as toluene or xylene. The trichlorosilyl reagent will add SiCl₃ to an unsaturated carbon. The formed trihalide silyl reagent then can be reacted with other silyl reagents to form Si-polymer with thio moieties.

As discussed above, photoresist compositions of the invention are preferably used in multiple-layer systems, i.e. where the photoimageable composition is disposed over a further organic (polymer composition) layer that itself is disposed over a substrate surface such as a microelectronic wafer or device substrate or an optical waveguide substrate.

Preferred underlayer compositions include those that comprise a phenolic polymer such as a novolak and/or poly(vinylphenol). Also preferred is where the underlying polymer composition is a crosslinking composition, e.g. contain an acid or acid generator compound such as a thermal acid generator compound and preferably a separate crosslinker component such as an amine-based material, e.g. a melamine or benzoguanamine resin. For such crosslinking composition, the applied underlayer may be crosslinked prior to application of the overcoated photoimageable composition, e.g. by suitable thermal treatment such as heating at 140° C., 150° C., 160° C., 180° C., 200° C. or 230° C. for a time sufficient for crosslinking such as 0.5, 1 or 2 minutes. The underlying polymer composition is suitably non-photoimageable and does not contain a photoacid generator compound.

Such a bottom layer is typically applied to or coated on a substrate by spin-coating or other procedure used to apply photoresist coating layers to a substrate. The bottom layer then may be hard baked such as at 230° C. for 2 minutes, after which the present photoimageable compositions are coated on the cured bottom layer. The bottom layers preferably contain an amount of a UV absorbing component, such as an anthracene dye, sufficient for optical density and etch performance. The bottom layers typically have a thickness of from 0.4 to 1 μm. The top layer of the present photoimageable compositions is typically from 0.05 to 1 μm thick, preferably from 0.1 to 0.5 μm, and more preferably from 0.1 to 0.3 μm.

Suitably, more than one silicon-containing polymer may be used in the present photoimageable compositions. Thus, the present photoimageable compositions may include one, two or more silicon-containing polymers. When two or more silicon-containing polymers are used, at least one is a silicon-containing polymer of the present invention. The remaining silicon-containing polymers may be conventional silicon-containing polymers or polymers of the present invention. In this way, blends of polymers may be advantageously used in the present photoimageable compositions. Such blends include blends of the present silicon-containing polymers with non-silicon-containing polymers. In these blends, any ratio of polymers is suitable. The specific ratio will depend upon the particular polymers combined and the characteristics (dissolution rate, etch resistance, photospeed, etc.) desired and are within the ability of one skilled in the art.

A wide variety of photoactive components may be used in the present invention, including, but not limited to, photoacid generators and photobase generators. Photoacid generators are preferred. It will be appreciated by those skilled in that art that more than one photoactive component may be used advantageously in the photoimageable compositions of the present invention.

The photoacid generators useful in the present invention are any compounds which liberate acid upon exposure to activating radiation, e.g. sub-300 nm radiation such as 248 nm, or sub-200 nm radiation such as 193 nm or 157 nm. Suitable photoacid generators include e.g. imidosulfonaytes, onium salts, halogenated triazines, sulfonated esters and halogenated sulfonyloxy dicarboximides.

Preferred PAGs for imaging at 157 nm, 193 nm and 248 nm imaging include imidosulfonates such as compounds of the following formula: 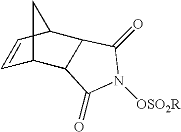
wherein R is camphor, adamantane, alkyl (e.g. C₁₋₁₂ alkyl) and perfluoroalkyl such as perfluoro(C₁₋₁₂alkyl), particularly perfluorooctanesulfonate, perfluorononanesulfonate and the like. Specifically preferred PAGs of this type are N-[(perfluorooctanesulfonyl)oxy]-5-norbornene-2,3-dicarboximide and N-(triflate)-5-norbornene-2,3-dicarboximide (MDT). N-(triflate)-5-norbornene-2,3-dicarboximide has the following structure:

Sulfonium and iodonium salts also suitable PAGs, particularly sulfonate salts. Two suitable agents for 193 nm and 248 nm imaging are the following PAGS 1 and 2:

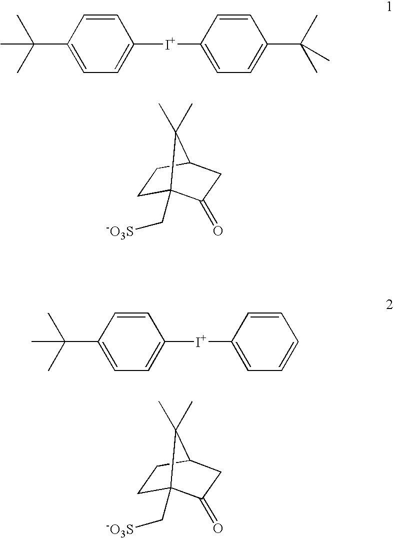

Such sulfonate compounds can be prepared as disclosed in European Patent Application 96118111.2 (publication number 0783136), which details the synthesis of above PAG 1.

Also suitable are the above two iodonium compounds complexed with anions other than the above-depicted camphorsulfonate groups. In particular, preferred anions include those of the formula RSO₃— where R is adamantane, alkyl (e.g. C₁₋₁₂ alkyl) and perfluoroalkyl such as perfluoro (C₁₋₁₂alkyl), particularly perfluorooctanesulfonate, perfluorobutanesulfonate and the like.

For imaging at 157 nm, a triphenyl sulfonium PAG is particularly preferred, complexed with anions such as the sulfonate anions mentioned above, particularly a perfluoroalkane sulfonate such as perfluorobutane sulfonate.

Particularly useful halogenated triazines include halomethyl-s-triazines. Suitable halogenated triazines include for example, 2-(1-(3,4-benzodioxolyl))-4,6-bis(trichloromethyl)-1,2,5-triazine, 2-(1-(2,3-benzodioxolyl))-4,6-bis(trichloromethyl)-1,3,5-triazine, 2-(1-(3,4-benzodioxolyl))-4,6-bis(tribromomethyl)-1,3,5-triazine, 2-(1-(2,3-benzodioxolyl))-4,6-bis(tribromomethyl)-1,3,5-triazine, and 2-(2-furfylethylidene)-4,6-bis(trichloromethyl)-1,3,5-triazine. Other triazine type photoacid generators useful in the present invention are disclosed in U.S. Pat. No. 5,366,846, herein incorporated by reference.

Halogenated sulfonyloxy dicarboximides also will be useful as photoacid generators such as: 1-(((trifluoromethyl)sulfonyl)oxy)-1H-pyrrole-2,5-dione; N-((perfluorooctanesulfonyl)oxy)-5-norbornene-2,3-dicarboximide; N-((trifluoromethylsulfonyl)oxy)-5-norbornene-2,3-dicarboximide; I-(((trifluoromethyl)sulfonyl)oxy)-2,5-pyrrolidinedione; 3a,4,7,7a-tetrahydro-2-(((trifluoromethyl)sulfonyl)oxy)-4,7-methano-1H-isoindole-1,3 (2H)-dione; 2-(((trifluoromethyl)sulfonyl)oxy)-1H-benz(f)isoindole-1,3(2H)-dione; 3,4-dimethyl-1-(((trifluoromethyl)sulfonyl)oxy)-1H-pyrrole-2,5-dione; 2-(((trifluoromethyl)sulfonyl)oxy)-1H-isoindole-1,3(2H)-dione; and 2-(((trifluoromethyl)sulfonyl)oxy)-1H-benz(de)isoquinoline-1,3(2H)-dione.

In positive-acting systems of the present invention, the photoactive components are typically added to photoimageable compositions in an amount sufficient to generate a latent image in a coating layer of resist material upon exposure to activating radiation. When the photoactive component is a photoacid generator, the amount is typically in the range of 0.1 to 15 percent by weight, based on the weight of the resin, and preferably 1 to 8 percent by weight.

In negative-acting systems of the present invention, the amount of photoactive component useful is any amount sufficient to catalyze cross-linking of the silicon-containing polymer or oligomer. The photoactive components are typically used in the range of 0.1 to 25% by weight, based on the weight of the composition. It is preferred that the photoactive component is present in an amount in the range of 0.1 to 15% by weight, more preferably in the range of 0.1 to 12% by weight, and still more preferably less than or equal to 5% by weight. A particularly suitable range is from 0.1 to 5% by weight.

Negative-acting resist preferably include one or more cross-linking agents. Any aromatic or aliphatic cross-linking agent that reacts with the silicon-containing polymer or oligomer is suitable for use in the present invention. Such organic cross-linking agents will cure to form a polymerized network with the silicon-containing polymer or oligomer, and reduce solubility in selected solvents. Such organic cross-linking agents may be monomers or polymers. It will be appreciated by those skilled in the art that combinations of cross-linking agents may be used successfully in the present invention.

Suitable organic cross-linking agents useful in the present invention include, but are not limited to: amine containing compounds, epoxy containing materials, compounds containing at least two vinyl ether groups, allyl substituted aromatic compounds, and combinations thereof. Preferred cross-linking agents include amine containing compounds and epoxy containing materials.

The amine containing compounds useful as cross-linking agents in the present invention include, but are not limited to: a melamine monomers, melamine polymers, alkylolmethyl melamines, benzoguanamine resins, benzoguanamine-formaldehyde resins, urea-formaldehyde resins, glycoluril-formaldehyde resins, and combinations thereof. These resins may be prepared by the reaction of acrylamide or methacrylamide copolymers with formaldehyde in an alcohol-containing solution, or alternatively by the copolymerization of N-alkoxymethylacrylamide or methacrylamide with other suitable monomers. Particularly suitable amine-based crosslinkers include the melamines manufactured by Cytec of West Paterson, N.J., such as CYMEL™ 300, 301, 303, 350, 370, 380, 1116 and 1130; benzoguanamine resins such as CYMEL™ 1123 and 1125; the glycoluril resins CYMEL™ 1170, 1171 and 1172; and the urea-based resins BEETLE™ 60, 65 and 80, also available from Cytec, West Paterson, N.J. A large number of similar amine-based compounds are commercially available from various suppliers.

Melamines are the preferred amine-based cross-linkers. Particularly preferred are alkylolmethyl melamine resins. These resins are typically ethers such as trialkylolmethyl melamine and hexaalkylolmethyl melamine. The alkyl group may have from 1 to 8 or more carbon atoms but is preferably methyl. Depending upon the reaction conditions and the concentration of formaldehyde, the methyl ethers may react with each other to form more complex units.

Particularly suitable amine-based cross-linking agents include those of the following formula: 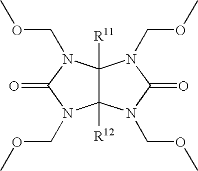
wherein R¹¹ and R¹² are independently selected from H, (C₁-C₆)alkyl and phenyl. Preferred alkyl groups for R¹¹ and R¹² are methyl and propyl.

Epoxy containing materials useful as cross-linkers in the present invention are any organic compounds having one or more oxirane rings that are polymerizable by ring opening. Such materials, broadly called epoxides, include, but are not limited to: monomeric epoxy compounds, and polymeric epoxides that may be aliphatic, cycloaliphatic, aromatic or heterocyclic. Preferred epoxy cross-linking materials generally, on average, have at least 2 polymerizable epoxy groups per molecule. The polymeric epoxides include linear polymers having terminal epoxy groups (e.g., diglycidyl ether of a polyoxyalkylene glycol), polymers having skeletal oxirane units (e.g., polybutadiene polyepoxide), and polymers having pendant epoxy groups (e.g., glycidyl methacrylate polymer of copolymer). The epoxides may be pure compounds but are generally mixtures containing one, two or more epoxy groups per molecule.

Useful epoxy-containing materials may vary from low molecular weight monomeric materials and oligomers to relatively high molecular weight polymers and may vary greatly in the nature of their backbone and substituent groups. For example, the backbone may be of any type and substituent groups may be any group free of any substituents reactive with an oxirane ring at room temperature. Suitable substituents include, but are not limited to: halogens, ester groups, ethers, sulfonate groups, siloxane groups, nitro groups, phosphate groups, and the like. Particularly useful epoxy containing materials in the present invention include glycidyl ethers. Examples are the glycidyl ethers of polyhydric phenols obtained by reacting a polyhydric phenol with an excess of chlorohydrin such as epichlorohydrin (e.g., the diglycidyl ether of 2,2-bis-(2,3-epoxypropoxyphenol)propane). Such glycidyl ethers include bisphenol A epoxides, such as bisphenol A ethoxylated diepoxide. Further examples of epoxides of this type are described in U.S. Pat. No. 3,018,262, herein incorporated herein by reference to the extent this patent teaches the preparation of such epoxides.

The compositions of the present invention may suitably comprise only a single type of organic cross-linker, e.g., only an amine containing cross-linker, or may contain two or more different cross-linkers. When a combination of organic cross-linkers is used in the present invention, it is preferred that the combination include an amine containing compound and an epoxy containing compound. The concentration of organic cross-linking agents in the compositions of the present invention may vary within a relatively wide range. It will be appreciated by those skilled in the art that suitable organic cross-linker concentrations will vary with factors such as cross-linker reactivity and specific application of the composition. Typically, the cross-linking agent(s) is present in an amount in the range of 0.1 to 80% by weight, based on the total weight of the composition, preferably in the range of 0.5 to 50%, and more preferably in the range of 1 to 25%. It is preferred that a cross-linking agent is used in the compositions of the present invention.

Photoresist compositions of the present invention may optionally further include one or more additional components, including, but not limited to, solvents, anti-striation agents, plasticizers, surfactants, base additives, speed enhancers, fillers, dyes and the like. In positive-acting systems, a base additive is typically used to adjust the photospeed of the composition. Such optional additives will be present in relatively minor concentrations in a photoresist composition except for fillers and dyes which may be used in relatively large concentrations, e.g. in amounts of from about 5 to 30 percent by weight, based on the total weight of the composition's dry components.

Photoresists of the invention may be readily prepared by those skilled in the art. For example, a photoresist composition of the invention can be prepared by dissolving the components of the photoresist, i.e. polymer binder and photoactive component, in a suitable solvent. Such suitable solvents include, but are not limited to: ethyl lactate, ethylene glycol monomethyl ether, ethylene glycol monomethyl ether acetate, propylene glycol monomethyl ether, propylene glycol monomethyl ether acetate, 3-ethoxyethyl propionate, 2-heptanone, butyrolactone, and mixtures thereof.

Typically, the solids content of the photoresist composition varies from about 5 to about 35 percent by weight, based on the total weight of the composition. The resin binder and photoactive components should be present in amounts sufficient to provide a film coating layer and formation of good quality latent and relief images.

Such photoresist compositions may be applied to a substrate by any known means, such as spinning, dipping, roller coating and the like. When the compositions are applied by spin coating, the solids content of the coating solution can be adjusted to provide a desired film thickness based upon the specific spinning equipment utilized, the viscosity of the solution, the speed of the spinner and the amount of time allowed for spinning.

After being coated on a bottom layer if employed, the present photoresist composition top layer is dried by heating (baked) to remove any solvent. It is preferably dried until the coating is tack free. Thereafter, it is imaged through a mask in a conventional manner. The exposure is sufficient to effectively activate the photoactive component of the photoresist to produce a patterned image in the resist coating layer, and more specifically, the exposure energy typically ranges from about 1 to 100 mJ/cm², dependent upon the exposure tool and the components of the photoresist composition.

As discussed, photoresists of the invention may be activated by a variety of exposure wavelengths, such as 248, 193, 157 nm and 11-15 nm. Photoresists of the invention also may be used with other radiation sources, such as, but not limited to, visible, e-beam, ion-beam and x-ray.

Following exposure, the film top layer of the composition is preferably baked at temperatures ranging from about 70° C. to 160° C. Thereafter, the top layer film is developed to form an etch pattern. Suitable developers include aqueous based developer, such as quaternary ammonium hydroxide solutions, such as tetra-alkyl ammonium hydroxide, preferably a 0.15 to 0.26 N tetramethylammonium hydroxide; various amine solutions, such as ethylamine, n-propylamine, diethylamine, triethylamine or methyl diethylamine; alcohol amines, such as diethanolamine, triethanolamine; cyclic amines, such as pyrrole, pyridine, and the like. One skilled in the art will appreciate which development procedures should be used for a given system.

The pattern is next transferred to the underlayer or bottom layer by etching, such as with an oxygen reactive ion etch process. After such processing, the resists, both top and bottom layers, may be removed from the processed substrate using stripping procedures known in the art.

Photoresists of the invention are useful in a wide variety of applications where photoresists are typically used. For example, the compositions may be applied over silicon wafers or silicon wafers coated with silicon dioxide for the production of microprocessors and other integrated circuit components. Aluminum-aluminum oxide, gallium arsenide, ceramic, quartz, copper, glass, spin-on organic dielectrics, spin-on or chemical vapor deposited inorganic dielectrics, and the like are also suitable employed as substrates for the photoresist compositions of the invention. Other chemical vapor deposited layers, such as cap layers, etch stops and the like, may also be used as substrates.

Alternatively, the present compositions may also be used in optoelectronics applications, such as in the manufacture of optical waveguides. By “optical waveguide” is meant any device that transmits optical radiation across a two-dimensional substrate surface. Suitable optical waveguides include, but are not limited to, splitters, couplers, spectral filters, polarizers, isolators, wavelength division multiplexing structures, and the like. Such waveguides may also contain active functionality, such as amplification and switching such as with electro-optic, thermo-optic or acousto-optic devices. To be useful as amplifiers, the present waveguides typically contain one or more dopants. Erbium is an exemplary dopant. Such dopants are well known in the art. Thus, the present waveguides suitable for use as amplifiers contain one or more dopants.

Waveguides of the present invention may be manufactured as individual waveguides or as an array of waveguides. Whether such waveguides are prepared as an array depends on the particular use and is within the ability of one skilled in the art.

In one embodiment, optical waveguides may be prepared by first disposing a layer of the present compositions on a substrate by any means including, but not limited to, screen coating (or screen printing), curtain coating, roller coating, slot coating, spin coating, flood coating, electrostatic spray, spray coating, dip coating or as a dry film. When the compositions of the present invention are spray coated, a heated spray gun may optionally be used. The viscosity of the composition may be adjusted to meet the requirements for each method of application by viscosity modifiers, thixotropic agents, fillers and the like. Any substrate suitable for supporting a waveguide may be used with the present compositions. Suitable substrates include, but are not limited to, substrates used in the manufacture of electronic devices such as printed wiring boards and integrated circuits. Particularly suitable substrates include laminate surfaces and copper surfaces of copper clad boards, printed wiring board inner layers and outer layers, wafers used in the manufacture of integrated circuits, liquid crystal display (“LCD”) glass substrates and the like.

The coated substrate is typically then cured, such as by baking, to remove any solvent. Such curing may be a variety of temperatures, depending upon the particular solvent chosen. Suitable temperatures are any that are sufficient to substantially remove any solvent present. Typically, the curing may be at any temperature from room temperature (i.e., 25° C.) to 170° C. Such curing typically occurs over a period of from 5 seconds to 30 minutes. Such curing may be affected by heating the substrate in an oven or on a hot plate.

After curing, the layer of the present composition disposed on the substrate is then imaged by exposure to actinic radiation through appropriate artwork or a mask. Following exposure, the composition is then cured at a temperature of from 40° to 170° C. Curing time may vary but is generally from about 30 seconds to about 1 hour. While not intending to be bound by theory, it is believed that upon exposure to actinic radiation the silsesquioxane oligomer cross-links, particularly with the optional cross-linking agent. The exposed areas are rendered less soluble than the unexposed areas. Thus, the unexposed areas may be removed, such as by contact with a suitable solvent, aqueous developer or solvent-water mixture, leaving only the exposed areas remaining on the substrate. Suitable aqueous developers include alkali metal hydroxides such as sodium hydroxide and potassium hydroxide in water as well as tetraalkylammonium hydroxide in water. Such developers are typically used in concentrations from 0.1 to 0.3 N, such as 0.15 to 0.26 N tetramethylammonium hydroxide in water. The choice of developer is well within the ability of those skilled in the art. Such development may be at a variety of temperatures such as from room temperature to about 100° C. The time of such development depends upon the material to be removed and the temperature used, but is generally from about 10 seconds to about 1 hour.

Following development, the present waveguides may undergo a final cure step, or re-flow step. In such final cure step, the waveguides may be heated at a temperature in from about 130° to 225° C. in air or inert atmospheres such as nitrogen or argon. Such final cure step aids in removal of residual solvent, removal of hydroxyl groups from the silsesquioxane polymer such as by increasing the extent of cross-linking, alter the waveguide profile such as to reduce surface roughness, and improves the optical transmission properties of the material.

Optical waveguides typically have a core and a cladding, wherein the cladding has a lower index of refraction as compared to the core. Particularly useful waveguides have core having an index of refraction of from 1.4 to 1.55. Typically, suitable cladding has an index of refraction of from 1.3 to 1.54.

It is preferred that a cladding layer is first deposited on a substrate. If the cladding layer is photocurable or thermocurable, it may be blanket cured as a first step. The photodefinable core material is then deposited on the cladding layer, imaged and the unexposed areas optionally removed. A second cladding layer is then deposited on the imaged waveguide. The second cladding layer may be the same or different from the first cladding layer. However, the indices of refraction of the first and second cladding layers should be the same. The second cladding layer is then cured, or imaged in the case of a photocurable cladding composition, to provide a waveguide structure.

Photoresists of the invention, particularly negative-acting photoresists of the invention, also may be employed in the cladding and/or core of optical waveguides. Preferably, the present photodefinable compositions are used to prepare cores for optical waveguides.

In an alternate embodiment, photoresists of the invention may be used to make porous optoelectronic devices, such as porous core and/or cladding materials in waveguides. Such porous optoelectronic devices may be prepared according to the same methods used to prepare porous dielectric materials.

All documents mentioned herein are incorporated herein by reference. The following non-limiting examples are illustrative of the invention.

### EXAMPLES 1-6

### Synthesis of Polymers Useful in Photoresists of the Invention

### Example 1

### Phenolic Si-Polymer Particularly Useful for 248 nm Resist

Poly(4-hydroxybenzyl silsesquioxane) (254.7 g) is dissolved in 1000 mL dry acetone under nitrogen atmosphere in a dried 3 L flask (reactor). Methanesulfonyl chloride (23.8 g) is added and the reactor is cooled to 15° C. A solution of distilled triethylamine (21.9 g) and acetone (22 g) is gradually added dropwise over 20-30 minutes, maintaining a reaction temperature of less than 30° C. Stirring is continued for 3 hours, at which time the solution is added dropwise over 2 h. to 32 L of water, precipitating the polymer. The polymer is then collected by suction filtration, and suspended in 8 L of water with stirring at room temperature for 18 h. The solid is then collected by suction filtration, is washed with water until the effluent is pH neutral, air-dried for 48 h., and is then dried in vacuo for 24 h. at 70° C. to yield an off-white polymer, having the formula 95 mol % hydroxybenzylsilsesquioxane/5 mol % mesylatedbenzylsilsesquioxane. Yield: 246 g (85% of theory). GPC data (RI detection): Mw=6,362; Mn=3,448; molecular weight polydispersity=1.84. T_{g}=90° C. Dissolution Rate (0.26 N TMAH)=5,591 Å/sec. The resulting isolated polymer contains 5-7% methanesulfonation, as determined by ¹H NMR.

### Example 2

### Phenolic Si-Polymer Particularly Useful for 248 nm Resist

A polymer with a higher mesylation level of 22% per molar equivalent of hydroxybenzyl group is prepared by the method of Example 1, except that the following reagent and solvent proportions are used: poly(4-hydroxybenzyl silsesquioxane) (63.7 g) in 250 mL dry acetone; methanesulfonyl chloride (13.8 g) in 9.3 g acetone; and triethylamine (12.6 g) in 17.4 g acetone. A 1 L reaction flask is used. Workup volumes are 8 L deionized water for precipitation, and 2 L deionized water for slurrying. The resulting polymer has the formula 78 mol % hydroxybenzylsilsesquioxane/22 mol % mesylatedbenzylsilsesquioxane. Yield: 61 g (71% of theory); GPC(RI detection): Mw=5,571, Mn=3,456; molecular weight polydispersity=1.61. T_{g}=97° C. Dissolution Rate (0.26 N TMAH)=5,591 Å/sec. The isolated polymer is typically between 21-23% methanesulfonated, as determined by ¹H NMR and as shown by the following general formula where x=0.79-0.77 and y=0.21-0.23.

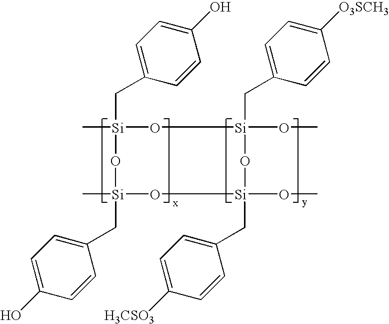

### Example 3

### Si-Polymer Particularly Useful for 193 nm Resist

The following polymer was prepared as shown in the following Scheme.

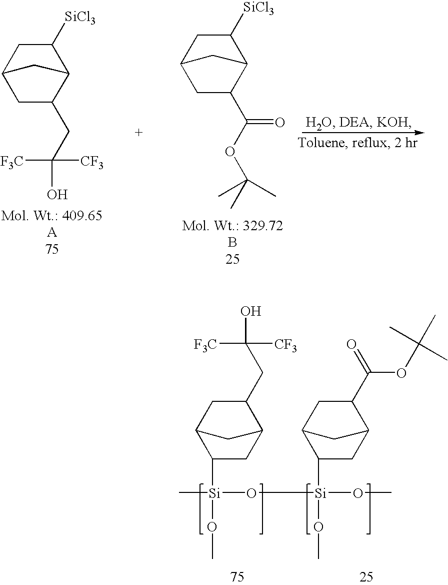

A reaction vessel was charged as follows:

| | | |
|---|---|---|
| Monomer A: | 15.36 | g (0.0375 mol) |
| Monomer B: | 4.11 | g (0.0125 mol) |
| Toluene: | 40 | g (46 ml) |
| DI Water: | 16.8 | g |
| Diethylamine: | 10.97 | g (15.5 ml) |
| KOH: | 0.21 | g |

More specifically, to a 250 ml 3 necked round-bottom flask fitted with a thermometer and an addition funnel, gas inlet was added the solution of DEA (11 g), DI water (16.8 g) and toluene (10 ml). The flask temperature was between 0 to −5° C. To this chilled solution was added a mixture of the monomers (A and B as specified immediately above) and toluene (40 g) drop wise over a period of 55 min. (Note: at 0° C., there were two phases: a milky white bottom layer and a clear toluene top layer). After the addition was complete the whole mixture was allowed to come to RT and stirred for additional 1.5 hr. The two layers were separated by addition of extra water to dissolve the quaternary ammonium salt (observation: apart from the two layers, an oily white material was found in the flask which was not soluble in water as well as in toluene at room temperature. However the oily materials dissolved completely in toluene when it was heated to 50° C.) The toluene layer was washed with DI water (3×1500 ml). The pH was still around 9. It was further washed with 10% acetic acid (1×50 ml) and further washed with DI water to bring the pH to 7.

The toluene layer from above work-up was added into a 250 ml 3 necked RB flask (total solution was ˜200 ml) fitted with a thermometer, Dean-Stark trap and a condenser. To the total solution was added 0.21 g of KOH dissolved in 1 ml DI water followed by 1.0 ml of DI water rinse. The mixture was heated to reflux to azeotrope water that was added to the reaction and formed during condensation. The reflux was continued for 2 hr (Note: during reflux, removed toluene (10 mL)/water (3 mL) mixture from the Dean Stark condenser). After 2 hr reflux, the solution was brought into RT and washed with 20% acetic acid (2×50 ml) further with DI water until the pH=7. The toluene solution was washed with ion-exchange resin (IRN-150) for 2 hr. Filtered the resins and toluene was removed and the polymer was dried at 50° C. overnight. The final polymer was analyzed by various techniques such as: ¹H, ¹³C and ²⁹Si NMR, GPC-PDA, DSC, TGA, Base content, FT-IR, MALDI-TOF.

The number of OH (silanol) group per silicon atom was calculated by using ²⁹Si NMR and was found to be found to be 0.2.

### Example 4

### Si-polymer Particularly Useful for 193 nm Resist

Experimental procedure for the preparation of a preferred polysilsesquioxane useful in a photoresist imaged at 193 nm is as follows:

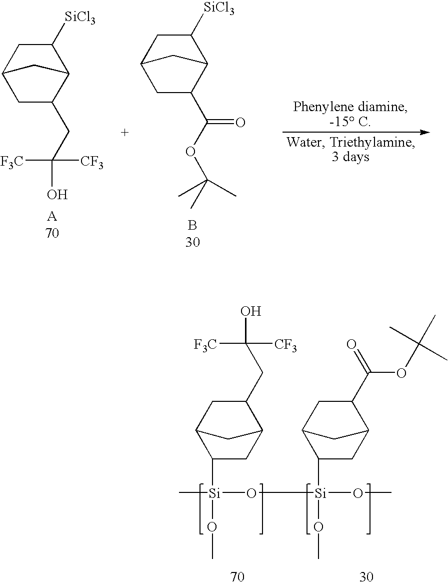

A reaction vessel was charged as follows:

| | | |
|---|---|---|
| Monomer A: | 10.4 | g (0.036 mol) |
| Monomer B: | 34.0 | g (0.084 mol) |
| Phenylenediamine: | 6.9 | g |
| Triethylamine: | 36 | mL |
| Tetrahydrofuran: | 260 | mL |
| Toluene: | 150 | mL |
| DI Water: | 4.3 | mL |

A solution of 6.9 g of 1,4-phenylenediamine, 12 ml of triethylamine and 160 ml of THF was added drop wise to a three necked flask containing 10.4 g of monomer A and 34.0 g of monomer B in 150 ml of toluene at −15° C. This solution was stirred for 30 min at low temperature (−15° C.) after which 4.3 ml of water and 24 ml of triethylamine and 100 ml of THF were added drop wise to the flask at −5° C. This mixture was stirred at this temperature for additional 3 h then washed with water until neutral and dried with anhydrous sodium sulfate overnight. The final solution from the above reaction was stirred in the presence of molecular sieves (4A) and a 1 ml of triethylamine at 50° C. for 72 h. After 72 h, the polymer solution was washed with water until neutral and the solvent was distilled off. The solid polymer was dissolved in minimum amount of THF and precipitated in water (twice) and dried in vacuum at 50° C. for 24 h. The final polymer was analyzed by various techniques such as: ¹H, ¹³C and ²⁹Si NMR, GPC-PDA, DSC, TGA, Base content, FT-IR, MALDI-TOF.

### Example 5

### Polymer Containing Sulfonamide Units

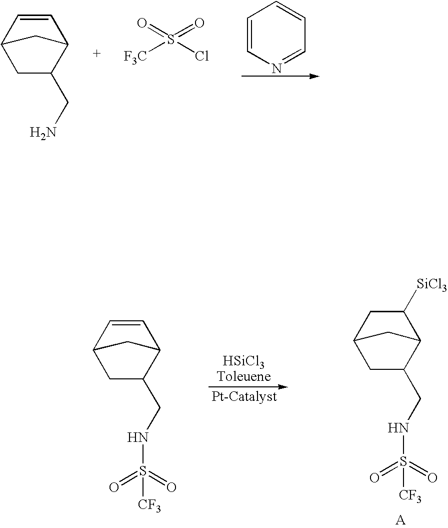

The silyl norbornyl sulfonamide monomer designated as “A” in the immediately above scheme was prepared as follows.

All reaction glassware was dried in the oven overnight at 100° C. The glassware was set up and cooled under a stream of nitrogen. The reaction was carried out under a blanket of nitrogen.

Into a dry 250 ml 3 necked flask quipped with a magnetic stirrer, condenser and an addition funnel was added 80 ml dry tetrahydrofuran, 9.7 g of pyridine and 12.3 g of Norbornene amine. The reaction mixture was cooled to 0° C. and 16.9 g of trifluoromethanesulfonylchloride was added to this mixture and stirred for 4 h. After stirring for 4 h, the pyridinium salt was filtered off and the THF was evaporated to dryness. The resulting solid was dissolved in diethylether and washed with 3.5% HCl followed by DI water till the pH 7. The ether was dried over sodium sulphate and evaporated the solvent to get an oily product. The product was analyzed by 1H, 13C and 19F NMR and it was further hydrosilylated by the following procedure:

A 100 ml 2 necked round bottomed flask quipped with refluxing condenser and an addition funnel flushed with nitrogen for 10 min and charged 200 mg of platinum-divinyltetramethyldisiloxane complex and 25 ml of toluene. The mixture was stirred at room temperature. 10.0 g of the above mixture was added (all at once) to this clear solution followed by the drop wise addition of 20 g of trichlorosilane (total addition time ˜10 min) at room temperature. The whole mixture was stirred at 50° C. for 48 h, after which the solvent and the unreacted starting materials were distilled off. The crude product was subjected to ¹H & ¹³C NMR (yield>95%).

Polycondensation Reaction:

To a 250 ml 3 necked round bottom flask fitted with a thermometer and an addition funnel, gas inlet was added the solution of DEA (11 g), DI water (16.8 g) and toluene (10 ml). The flask temperature was between 0 to −5° C. To this chill solution was added a mixture of the monomers (A and B) and toluene (40 g) drop wise over a period of 55 min. (Note: at 0° C., there were two phases: a milky white bottom layer and a clear toluene top layer). After the addition was complete the whole mixture was allowed to come to RT and stirred for additional 1.5 hr. The two layers were separated by addition of extra water to dissolve the quart. amm. Salt (Observation: apart from the two layers, an oily white material was found in the flask which was not soluble in water as well as in toluene at room temperature. However the oily materials dissolved completely in toluene when it was heated to 50° C. The toluene layer was washed with DI water (3×1500 ml). The pH was still around 9. It was further washed with 10% acetic acid (1×50 ml) and further washed with DI water to bring the pH to 7.

The toluene layer from above work-up was added into a 250 ml 3 necked RB flask (total solution was ˜200 ml) fitted with a thermometer, Dean-Stark trap and a condenser. To the total solution was added 0.21 g of KOH dissolved in 1 ml DI water followed by 1.0 ml of DI water rinse. The mixture was heated to reflux to azeotrope water that was added to the reaction and formed during condensation. The reflux was continued for 2 hr (Note: during reflux, removed toluene (10 mL)/water (3 mL) mixture from the Dean Stark condenser). After 2 hr reflux, the solution was brought into RT and washed with 20% acetic acid (2×50 ml) further with DI water until the pH=7. The toluene solution was washed with ion-exchange resin (IRN-150) for 2 hr. Filtered the resins and toluene was removed and the polymer was dried at 50° C. overnight.

### Example 6

### Polymer-Particularly Suitable for Negative Bilayer Resist

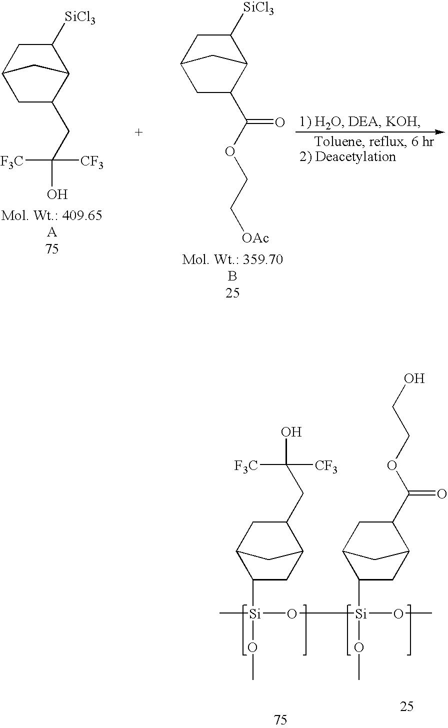

Monomer A Synthesis

| | Amt | Amt | | |
|---|---|---|---|---|
| Material | (g) | (ml) | Moles | Source |
| 3-(5-bicyclo[2.2.1]hepten-2- | 50 | | 0.182 | Central |
| yl)-1,1,1-trifluoro-2- | | | | Glass |
| (trifluoromethyl)propan-2-ol | | | | |
| Trichlorosilane | 100 | ˜75 | 0.738 | Gelest |
| Toluene | | 175 | | |
| Pt(divinyltetramethyl) | | 5 drops | | |
| disiloxane complex | | | | |

All reaction glassware was dried in the oven overnight at 100° C. The glassware was set up and cooled under a stream of nitrogen. The reaction was carried out under a blanket of nitrogen.

To a 500 ml 3N-RB flask fitted with a gas inlet, thermometer, overhead stirrer, condenser and a glass stopper was added 50 g 3-(5-bicyclo[2.2.1]hepten-2-yl)-1,1,1-trifluoro-2-(trifluoromethyl)propan-2-ol 100 ml of toluene and the catalyst. To this solution was added the trichlorosilane followed by the remainder of the toluene (75 ml). The mixture was heated to 50-51 C using a heating mantel. The reaction was held at 50-51 C for 36 hours. The reaction was cooled to room temperature and the excess trichlororsilane and toluene were removed under reduced pressure leaving 67 g of a crude oil. The product was purified by high vacuum distillation to give 63.3 g of product (74C/<1 mm).

Monomer B was also prepared by the same procedure.

Polycondensation Reaction:

Charge:

| | | |
|---|---|---|
| A: | 19.88 | g (0.04852 mole) |
| B: | 5.99 | g (0.01665 mole) |
| Toluene: | 60 | ml |
| Acetone: | 5 | ml |
| DI Water: | 34 | g |
| Diethylamine: | 22 | g; |
| KOH: | 0.4 | g in |
| | 3 | ml water |

To a 250 ml 3 necked round bottom flask fitted with a thermometer and an addition funnel, gas inlet was added the solution of DEA (22 g), DI water (34 g) and toluene (10 ml). The flask temperature was between 0 to −5° C. To this chilled solution was added a mixture of the monomers (A and B) and toluene (50 g) drop wise over a period of 55 min. (Note: at 0° C., there were two phases: a milky white bottom layer and a clear toluene top layer). After the addition was complete the whole mixture was allowed to come to RT and stirred for additional 1.5 hr. The two layers were separated by addition of extra water to dissolve the quart. amm. Salt The toluene layer was washed with DI water (3×1500 ml). The pH was still around 9. It was further washed with 10% acetic acid (1×50 ml) and further washed with DI water to bring the pH to 7.

The toluene layer from above work-up was added into a 250 ml 3 necked RB flask (total solution was ˜175 ml) fitted with a thermometer, Dean-Stark trap and a condenser. To the total solution was added 0.4 g of KOH dissolved in 2 ml DI water followed by 1.0 ml of DI water rinse. The mixture was heated to reflux to azeotrope water that was added to the reaction and formed during condensation. The reflux was continued for 4 hr (Note: during reflux, removed toluene/water mixture from the Dean Stark condenser). After 4 hr reflux, the solution was brought into RT and washed with 20% acetic acid (2×50 ml) further with DI water until the pH=7. The toluene solution was washed with ion-exchange resin (IRN-150) for 2 hr. Filtered the resins and toluene was removed and the polymer was dried at 50° C. overnight. The deprotection of acetyl group from one of the monomers was carried by refluxing the copolymer in presence of dilute ammonium hydroxide solution for 24 hr. The final polymer was characterized by ¹H, ¹³C & ²⁹Si NMR, GPC-PDA, DSC, TGA, Base content, FT-IR, MALDI-TOF MS.

### Example 7

### Synthesis of Additional Monomer Useful for Preparation of Polymers of the Invention

### NBTFE Silane Monomer Synthesis

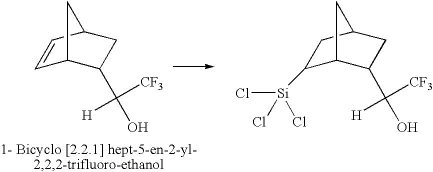

| | Amt | Amt | |
|---|---|---|---|
| Material | (g) | (ml) | Moles |
| 1-Bicyclo[2.2.1]hept-5- | 22 | | 0.114 |
| en-2-yl-2,2,2-trifluoro-ethanol | | | |
| Trichlorosilane | 50 | ˜36.5 | 0.368 |
| Toluene | | 75 | |
| Pt(divinyltetramethyl) | 0.15 | | |
| disiloxane complex | | | |

All reaction glassware was dried in the oven overnight at 100° C. The glassware was set up and cooled under a stream of nitrogen. The reaction was carried out under a blanket of nitrogen.

To a 300 ml 3N-RB flask fitted with a gas inlet, thermometer, overhead stirrer, condenser and a glass stopper was added 22 g 1-Bicyclo[2.2. I]hept-5-en-2-yl-2,2,2-trifluoro-ethanol, 75 ml of toluene and the catalyst. To this solution was added the trichlorosilane. The mixture was heated to 50-51 C using a heating mantel. The reaction was held at 50-51 C for 72 hours. The reaction was cooled to room temperature and the excess trichlororsilane and toluene were removed under reduced pressure leaving 34 g of a crude oil. NMR indicated all the staring material was consumed. Theoretical yield: 37.3 g.

### EXAMPLE 8-9

### Photoresist Preparation and Processing and Comparative Results

### Example 8

### Photoresist Preparation, Lithographic Processing and Aging Studies

A photoresist composition of the invention was prepared as follows. The photoresist was formulated at 9.125 weight percent solids in a solvent component of propylene glycol monomethyl ether acetate. The polymer, photoacid generator compounds (PAGs), base, sulfonic acid salt and surfactant were admixed as solutions of propylene glycol monomethyl ether acetate. The following components in the following amounts were admixed to form the photoresist:
1) Polymer: t-Boc/mesyl/HOBSSQ terpolymer of Example 1 above having 20 mole percent of phenolic units blocked with acid-labile t-Boc units;
2) First photoacid generator compound of N-(triflate)-5-norbornene-2,3-dicarboximide in an amount of 6.5 weight percent of the terpolymer;
3) Second photoacid generator compound of di-tert-butylphenyliodonium 2-trifluoromethylbenzenesulfonate in an amount of 2.634 weight percent of the terpolymer;
4) Sulfonic acid salt of Troger's base salt of triflic acid in an amount of 0.4 weight percent of the polymer;
5) Base additive of Troger's base in an amount of 0.3 weight percent of the polymer;
6) Silicon surfactant in an amount of 0.2 weight percent of total solids (total solids are all resist components except solvent of propylene glycol monomethyl ether acetate.

The thus prepared photoresist formulation was filtered through a 0.10 μm Teflon filter and applied by spin coating to a thickness of 1600±25 Å onto a crosslinked phenolic underlayer composition layer over a silicon wafer. The applied photoresist coating layer was soft baking at 90° C. for 60 seconds. The underlayer composition layer had been applied by spin coating onto a silicon wafer to a thickness of 5100 Å using a 60 second bake at 175° C.

The applied resist layer was exposed to 248 nm radiation through a binary photomask. Wafers were subjected to a post-exposure bake at 90° C. for 90 seconds and subsequently developed in a 0.26 N aqueous alkaline developer using a 45 second single puddle process.

That lithographic processing was conducted immediately after photoresist preparation and then for a photoresist sample that had been stored for 12 weeks at room temperature after resist preparation. High resolution images of 0.25 micron lines:spaces were formed by both the photoresist sample lithographically processed immediately after photoresist preparation and for the photoresist sample that was aged for 12 weeks prior to lithographic processing, i.e. no decrease in resolution was seen (SEM analysis) upon aging.

### Example 9

### Comparative Tests

The same photoresist composition was prepared as described in Example 8 above, except the photoresist composition did not contain the triflic acid salt or any other added sulfonic acid.

The thus prepared photoresist composition was lithographically processed in the same manner as described in Example 8 above with resist coating layers imaged and developed 1) immediately after resist preparation and then 2) after aging for 12 weeks at room temperature. The photoresist samples that had been aged for 12 weeks yielded a resist relief image (0.25 micron lines:spaces) that has inferior resolution including increased line roughness relative to the sample of the same photoresist composition that was lithographically processed immediately after resist preparation.

The foregoing description of the invention is merely illustrative thereof, and it is understood that variations and modifications can be effected without departing from the spirit or scope of the invention as set forth in the following claims.

1. A photoimageable composition comprising:
i) a photoactive component;
ii) a component that comprises one or more Si atoms; and
iii) a component that comprises one or more sulfonic acid moieties.

2. The photoimageable composition of claim 1 wherein the sulfonic acid component is a salt.

3. The photoimageable composition of claim 2 wherein the sulfonic acid component is an optionally substituted alkylsulfonic acid.

4. The photoimageble composition of claim 3 wherein the sulfonic acid component has one or more haloalkyl substitutents.

5. The photoimageable composition of claim 1 wherein the photoimageable composition comprises a resin with one or more Si atoms.

6. The photoimageable composition of claim 5 wherein the resin comprises photoacid-labile groups.

7. The photoimageable composition of claim 5 wherein the resin comprises aromatic groups.

8. The photoimageable composition of claim 5 wherein the polymer is substantially free of aromatic groups.

9. The photoimageable composition of claim 1 wherein the composition further comprises a basic component.

10. The photoimageable composition of claim 9 wherein the basic component is an amine.

11. The photoimageable composition of claim 1 wherein the photoimageable composition is formulated as a liquid coating composition and comprises a solvent component that comprises as a major portion one or more non-hydroxylic solvents.

12. The photoimageable composition of claim 11 wherein the photoimageable composition is free of any hydroxy-containing solvents.

13. The photoimageable composition of claim 11 wherein the photoimageable composition comprises a solvent of propylene glyocol methyl ether acetate.

14. The photoimageable composition of claim 11 wherein more than 60 weight percent of all solvent of the photoimageable composition is propylene glyocol methyl ether acetate.

15. The photoimageable composition of claim 11 wherein more than 80 weight percent of all solvent of the photoimageable composition is propylene glyocol methyl ether acetate.

16. The photoimageable composition of claim 11 wherein the only solvent of the photoimageable composition is propylene glyocol methyl ether acetate.

17. A method of forming a photoresist relief image comprising:
(a) applying a coating layer of a photoresist composition of claim 1 on a substrate;
(b) exposing the photoresist coating layer to patterned activating radiation and developing the exposed photoresist layer to provide a relief image.

18. The method of claim 17 wherein the photoresist coating layer is exposed to radiation having a wavelength of about 248 nm or 193 nm.

19. An article of manufacture having on at least one surface a coating layer of the photoresist composition of claim 1.

20. The article of claim 19 wherein the photoresist composition is coated on a microelectronic wafer substrate.
